(19) United States
(12) Patent Application Publication
(10) Pub. No.: US 2025/0385974 A1
(43) Pub. Date: Dec. 18, 2025

(54) INFORMATION PROCESSING APPARATUS, CONTROLLING METHOD OF INFORMATION PROCESSING APPARATUS, AND STORAGE MEDIUM

(71) Applicant: CANON KABUSHIKI KAISHA, Tokyo (JP)

(72) Inventor: RYUJI NAGAHARA, Kanagawa (JP)

(21) Appl. No.: 19/226,318

(22) Filed: Jun. 3, 2025

(30) Foreign Application Priority Data
Jun. 12, 2024 (JP) 2024-095253

(51) Int. Cl. H04N 1/00; H04N 1/32

(52) U.S. Cl. CPC H04N 1/00029; H04N 1/0001; H04N 1/00074; H04N 1/32101; H04N 1/32625; H04N 2201/0094; H04N 2201/3269

(57) ABSTRACT

An information processing apparatus is an information processing apparatus capable of executing jobs. The information processing apparatus obtains job information on a job selected from among the jobs executed in the information processing apparatus, and performs diagnosis on the selected job by using the job information. In the case where a type of job indicated in the obtained job information is a type of job involving transmission to an external apparatus connected via a network, the diagnosis using a signal for checking network connection with the external apparatus is performed. In the case where the type of job indicated in the obtained job information is not the type of job involving transmission to the external apparatus connected via the network, the diagnosis is performed without use of the signal.

### BACKGROUND

### Field

The present disclosure relates to a technique of diagnosing a failure factor of a job.

### Description of the Related Art

A multifunction peripheral not only performs printing and scanning but also executes jobs involving reception and transmission from and to a terminal connected via a network such as printing according to an instruction from the terminal and transmission of scanned image data obtained by scanning to the terminal.

The multifunction peripheral displays history information of jobs executed by the multifunction peripheral, on a user interface screen (UI screen). Since the history information of the jobs includes only OK (successful) or NG (failed) for an execution result of each job, it is difficult for a user to identify a failure factor of the executed job, and grasping a measure for resolving this failure factor takes a lot of time.

In this regard, Japanese Patent Laid-Open No. 2018-157297 discloses a method in which, in the case where a transmission error of transmission information occurs in communication performed with an information terminal via a router, information indicating an error type of the transmission error is obtained from the router to analyze a cause of occurrence of the transmission error, and a result of the analysis is presented to the user.

### SUMMARY

The information processing apparatus according to an aspect of the present disclosure is an information processing apparatus capable of executing jobs, obtains job information on a job selected from among the jobs executed in the information processing apparatus, and performs diagnosis on the selected job by using the job information, in a case where a type of job indicated in the obtained job information is a type of job involving transmission to an external apparatus connected via a network, the diagnosis using a signal for checking network connection with the external apparatus is performed, and in a case where the type of job indicated in the obtained job information is not the type of job involving transmission to the external apparatus connected via the network, the diagnosis is performed without use of the signal.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration example of a system;

FIG. 2 is a diagram illustrating a configuration example of an MFP;

FIG. 3 is a diagram illustrating an example of a job list screen;

FIG. 4 is a diagram illustrating an example of a network diagnosis result screen;

FIG. 5 is a diagram illustrating an example of a network diagnosis on-going screen;

FIG. 6 is a diagram illustrating an example of a network diagnosis setting screen;

FIG. 7 is a flowchart illustrating a flow of a network diagnosis process;

FIG. 8 is a diagram illustrating an example of a diagnosis result (detailed) screen;

FIG. 9 is a diagram illustrating an example of the diagnosis result (detailed) screen;

FIG. 10 is a diagram illustrating an example of the diagnosis result (detailed) screen; and

FIG. 11 is a diagram illustrating an example of the diagnosis result (detailed) screen.

### DESCRIPTION OF THE EMBODIMENTS

There is proposed a multifunction peripheral having a function of selecting a job executed by the multifunction peripheral and performing diagnosis relating to the selected job. Although a multifunction peripheral including network diagnosis as the function of performing the diagnosis is proposed, communication with an external apparatus and the like are performed in the network diagnosis, and the network diagnosis thus takes a lot of time. If the network diagnosis is executed every time the diagnosis is performed, the diagnosis takes time and is inconvenient for the user.

Accordingly, the present disclosure provides a technique of reducing the time required for the diagnosis.

An embodiment for carrying out a technique of the present disclosure is explained below in detail with reference to the drawings. Note that the following embodiment does not limit the technique of the present disclosure according to the scope of claims. Not all of combinations of features explained in the embodiment are necessarily essential for solving means of the technique of the present disclosure, and multiple features may be adopted in any combination. Note that the same configurations are explained while being denoted by the same reference numerals. Moreover, each of steps in the flowcharts are described with “S” added to the front.

### Embodiment 1

### System Configuration

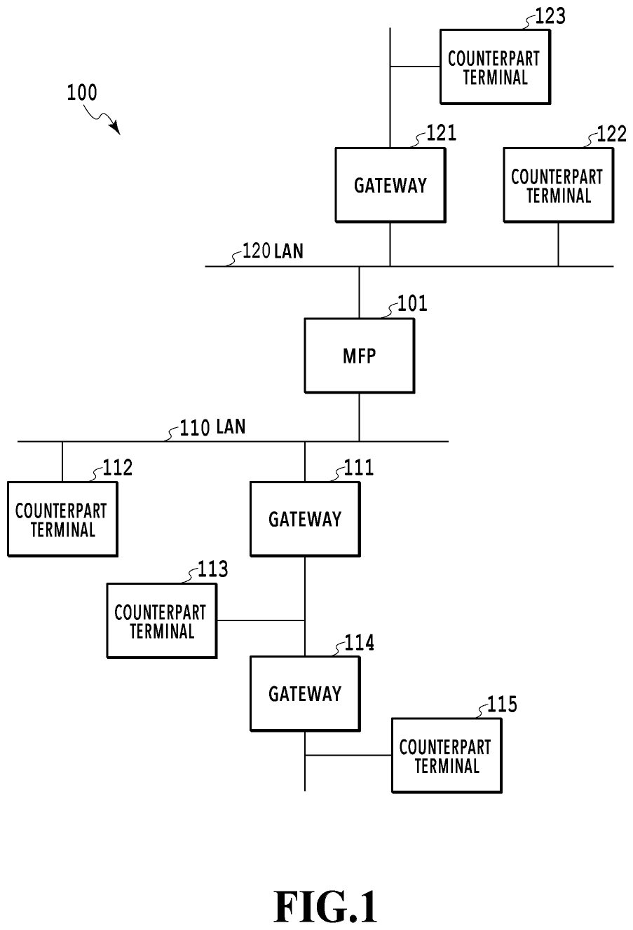

FIG. 1 is a diagram illustrating a configuration example of a system according to the present embodiment. In the present embodiment, a process of controlling network diagnosis is explained with a multifunction peripheral (MFP) having two communication lines of a main line and a sub-line given as an example. Although explanation is given with physically-different communication lines used as an example in this description, the present disclosure is not limited to this. For example, the present disclosure may be applied to communication lines virtually separated from each other by using a virtual network interface. Moreover, the present disclosure is not limited to the MFP, and may be applied to an information processing apparatus that provides other functions.

A system 100 of the present embodiment includes an MFP 101, a gateway 111, counterpart terminals 112 and 113, a gateway 114, a counterpart terminal 115, a gateway 121, and counterpart terminals 122 and 123. The MFP 101, the gateway 111, the counterpart terminals 112 and 113, the gateway 114, and the counterpart terminal 115 are connected to one another via a LAN 110 to be capable of mutually exchanging data. The MFP 101, the gateway 121, and the counterpart terminals 122 and 123 are connected to one another via a LAN 120 to be capable of mutually exchanging data.

The MFP 101 is a printing apparatus having a printing function, and may further have a reading function (scanner), a scan transmission function, a FAX function, and a phone function. Moreover, the MFP 101 has a communication function capable of performing data communication with the counterpart terminal 112, the counterpart terminal 113, and the counterpart terminal 115. The MFP 101, the counterpart terminal 112, the counterpart terminal 113, and the counterpart terminal 115 are connected to one another via the LAN 110, the gateway 111, and the gateway 114 to be capable of performing mutual communication. Meanwhile, the MFP 101, the counterpart terminal 122, and the counterpart terminal 123 are connected to one another via the LAN 120 and the gateway 121 to be capable of performing mutual communication.

The gateway 111 and the gateway 114 are network routers that relay communication from the MFP 101, between the MFP 101 and at least one of the counterpart terminal 113 and the counterpart terminal 115. The gateway 121 is a network router that relays communication from the MFP 101, between the MFP 101 and the counterpart terminal 123.

The counterpart terminal 113, the counterpart terminal 115, and the counterpart terminal 123 share files with the MFP 101 by using, for example, a server message block (SMB) protocol, and transmit a print request to the MFP 101. Moreover, the counterpart terminal 113, the counterpart terminal 115, and the counterpart terminal 123 serve a role of relaying communication, for example, in the case where the MFP 101 installed in an internal network that cannot perform (that does not allow) Internet connection connects to a web server or the like on the Internet. Specifically, the counterpart terminal 113, the counterpart terminal 115, and the counterpart terminal 123 each refer to a client personal computer (PC) having the above-mentioned function or a server PC such as a proxy server that serves the above-mentioned role.

### Hardware Configuration of Main Board

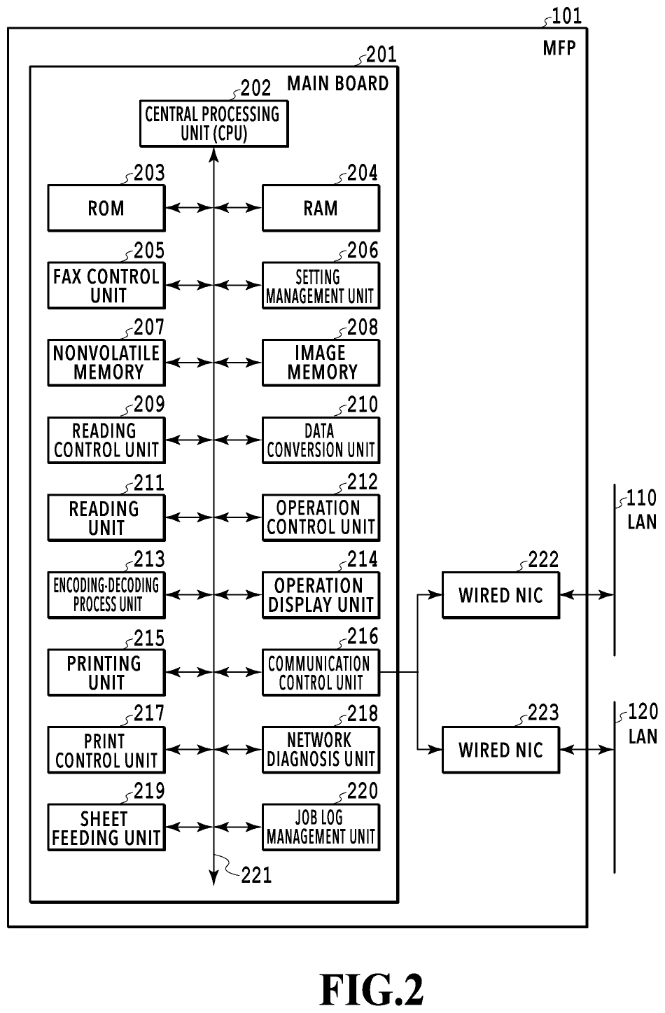

FIG. 2 is a diagram illustrating a configuration example of the MFP 101. The MFP 101 includes a main board 201 configured to perform main control of the MFP 101 itself and a wired network interface card (NIC) 222 and a wired NIC 223 configured to perform wired communication. For example, the main board 201 includes a central processing unit (CPU) 202, a ROM 203, a RAM 204, a nonvolatile memory 207, an image memory 208, a reading unit 211, an operation display unit 214, a printing unit 215, and a sheet feeding unit 219. The main board 201 further includes a FAX control unit 205, a setting management unit 206, a reading control unit 209, a data conversion unit 210, an operation control unit 212, an encoding-decoding process unit 213, a communication control unit 216, a print control unit 217, a network diagnosis unit 218, and a job log management unit 220. The above-mentioned components 203 to 220 in the main board 201 are connected to one another by a system bus 221 managed by the CPU 202.

The CPU 202 is a system control unit including at least one processor, and controls the entire MFP 101. For example, the CPU 202 implements processes of the MFP 101 to be explained below by executing programs stored in the ROM 203. Note that hardware dedicated to each process may be prepared. Control programs, an embedded OS program, and the like executed by the CPU 202 are stored in the ROM 203. In the present embodiment, the CPU 202 executes each of the control programs stored in the ROM 203 under management of the embedded OS similarly stored in the ROM 203 to perform software control such as scheduling and task switching.

The RAM 204 is a memory formed of a static RAM (SRAM) or the like, and is used as various work buffer regions by storing program control variables, setting values registered by the user, management data of the MFP 101, and the like.

The FAX control unit 205 performs control of facsimile transmission and reception via a not-illustrated modem.

The setting management unit 206 manages setting values of various functions included in the MFP 101. The various setting values include, for example, settings for sheets and image processes necessary for performing scanning and print processes and settings of communication with a communication terminal. These setting values are stored in the nonvolatile memory 207, and are held irrespective of a power state of the MFP 101. The setting management unit 206 performs control of reading the setting values from the nonvolatile memory 207 and control of changing the setting values to other setting values and storing the changed setting values in a nonvolatile region.

The nonvolatile memory 207 is formed of a memory such as, for example, a flash memory, and continues to store data even in the case where the power of the MFP 101 is turned off. The image memory 208 is formed of a memory such as a dynamic RAM (DRAM). The image memory 208 stores image data received via the wired NIC 222 and the wired NIC 223, image data processed in the encoding-decoding process unit 213, and the like. Note that the memory configuration of the MFP 101 is not limited to the above-mentioned configuration. For example, the image memory 208 and the RAM 204 may share the same memory. Moreover, although the DRAM is given as an example of the image memory 208 in the present embodiment, another storage medium such as a hard disk or a nonvolatile memory may be used.

The reading control unit 209 controls the reading unit 211 (for example, contact image sensor (CIS)) to convert an image obtained by optically reading an original placed on a platen glass to electrical image data (image signal) and output the image data. The reading control unit 209 may carry out various image processes such as a binarization process and a halftone process on the image data, and output the image data subjected to the image processes. Regarding an output destination of the image data, for example, the image data can be outputted to the printing unit 215, or transmitted to the counterpart terminal 112, the counterpart terminal 123, or the like. The reading control unit 209 notifies the job log management unit 220 of job process result information in the case where a reading process is completed. In the case where the job process fails, the reading control unit 209 instructs the network diagnosis unit 218 to execute a network diagnosis, and causes the network diagnosis result received from the network diagnosis unit 218 to be included in the job process result information to notify the job log management unit 220 of the network diagnosis result. Note that, although explanation is given with a scan job used as an example in the present embodiment, the present disclosure is not limited to this. In the case where the job process fails for a job (hereinafter, described as client job) that starts with transmission of a request from the MFP 101 to the counterpart terminal and in which the MFP 101 serves a role of a client, the network diagnosis unit 218 is similarly requested to perform the network diagnosis. The client job can be also referred to as a job that involves transmission to the counterpart terminal to which the MFP 101 is connected via the network.

The data conversion unit 210 performs analysis of data of various formats, conversion from the image data to print data, and the like.

The operation control unit 212 displays results of printing and transmission of scan data and a process result of the network diagnosis unit to be described later on the operation display unit 214 based on the display control of these results by the CPU 202, and executes operations such as generation of a signal according to reception of the user operation such as a scan instruction.

The encoding-decoding process unit 213 performs a coding process, a decoding process, and a scaling process of the image data (JPEG, PNG, or the like) handled in the MFP 101.

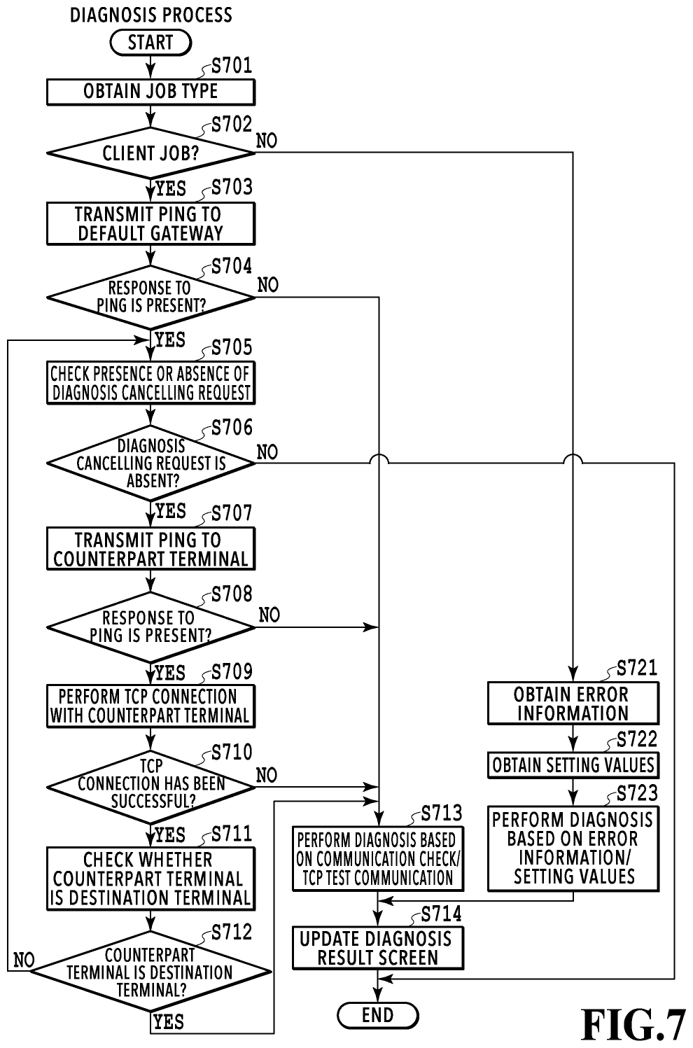

The print control unit 217 performs various image processes such as a smoothing process, a print density correction process, and color correction on the image data to be used in printing, and outputs the image data subjected to the image processes to the printing unit 215. For example, the printing unit 215 may be configured to be capable of executing an inkjet print process in which ink supplied from an ink tank is ejected from a print head and an image is printed on a print medium such as a sheet. Note that the printing unit 215 may be configured to be capable of executing other print processes such as an electrophotographic method. Moreover, the print control unit 217 also serves a role of regularly reading information on the printing unit 215 and updating information such as status information that is stored in the RAM 204 and that includes a remaining amount of the ink tank and a status of the print head. The image data to be printed is data included a print job received from the counterpart terminal 112, the counterpart terminal 123, or the like or data obtained from the reading unit 211 by the reading control unit 209. The print control unit 217 notifies the job log management unit 220 of the job process result information in the case where the print process is completed. In the case where the job process fails, the reading control unit 209 instructs the network diagnosis unit 218 to execute the network diagnosis, and causes the network diagnosis result received from the network diagnosis unit 218 to be included in the job process result information to notify the job log management unit 220 of the network diagnosis result. Note that, in the case where the client job fails, for example, the network diagnosis flow illustrated in FIG. 7 is performed to check communication with the counterpart terminal 112 or 122 and perform diagnosis for identifying a failure factor by performing TCP test communication. Meanwhile, in the case of a job (hereinafter, referred to as server job) such as the print job that starts with reception of a request from the counterpart terminal and in which the MFP 101 serves a role of a server, no communication check or TCP test communication is performed, and the processes described below are performed. Specifically, network diagnosis is performed by using error information determined in the print control unit 217 and setting information of the MFP 101 managed by the setting management unit 206 and saved in the nonvolatile memory 207. This is because, in the case of the server job, it is possible to determine that communication through a communication path between the MFP 101 and the counterpart terminal has no problem at a time point at which the process of the job starts. Note that the server job can be referred to as a job that involves reception from the counterpart terminal to which the MFP 101 is connected via the network.

The sheet feeding unit 219 holds sheets for printing, and can supply the sheets set in the sheet feeding unit 219 by being controlled by the print control unit 217. Particularly, the sheet feeding unit 219 may include multiple sheet feeding units to hold multiple types of sheets in one apparatus, and control of feeding sheets from which one of the sheet feeding units is performed by control of the print control unit 217.

The communication control unit 216 performs network communication control for sending scan data to the counterpart terminal 112, the counterpart terminal 123, or the like according to a transmission instruction from the reading control unit 209. In a configuration in which the wired NIC 222 and the wired NIC 223 are present as in the present embodiment, the MFP 101 holds two types of MAC address and IP address and can perform communication with the LAN 110 and the LAN 120 as a multihoming network environment. The communication control unit 216 performs communication control by identifying the counterpart terminals and establishing network connection in the multihoming network environment.

The wired NIC 222 and the wired NIC 223 are communication interfaces for communicating with other apparatuses via the local area network (LAN) 110 and the LAN 120. The wired NIC 222 and the wired NIC 223 can perform communication of a wired communication standard (IEEE 802.3) such as communication using an Ethernet (registered trademark) cable. The CPU 202 controls the wired NIC 222 and the wired NIC 223 via the communication control unit 216 to achieve data communication on the LANs 110 and 120. Note that, although a form in which the wired NIC 222 and the wired NIC 223 are installed in the MFP 101 is illustrated in the present embodiment, the present disclosure is not limited to this. For example, the present disclosure can be applied to other LAN devices and other connection forms such as a wireless LAN device and a LAN device connected to Universal Serial Bus (USB).

The job log management unit 220 manages information (result information) indicating the results of performing the print process and the scan process. Specifically, the job log management unit 220 manages information indicating the result of performing the server job and information indicating the result of performing the client job. The job process result information includes information indicating success or failure of each process. In the case where the process fails, the job process result information includes the network diagnosis result received from the network diagnosis unit 218 in some cases. The job process result information is stored in the nonvolatile memory 207 or a job log management server on the network, and is held irrespective of the power state of the MFP 101. The job log management unit 220 receives the results of the processes performed by the reading control unit 209 and the print control unit 217, and stores the process results in the nonvolatile memory 207 or the job log management server. Moreover, the job log management unit 220 reads the job process result information from the nonvolatile memory 207, and passes the job process result information to the operation control unit 212. The operation control unit 212 displays the job process result information on the operation display unit 214.

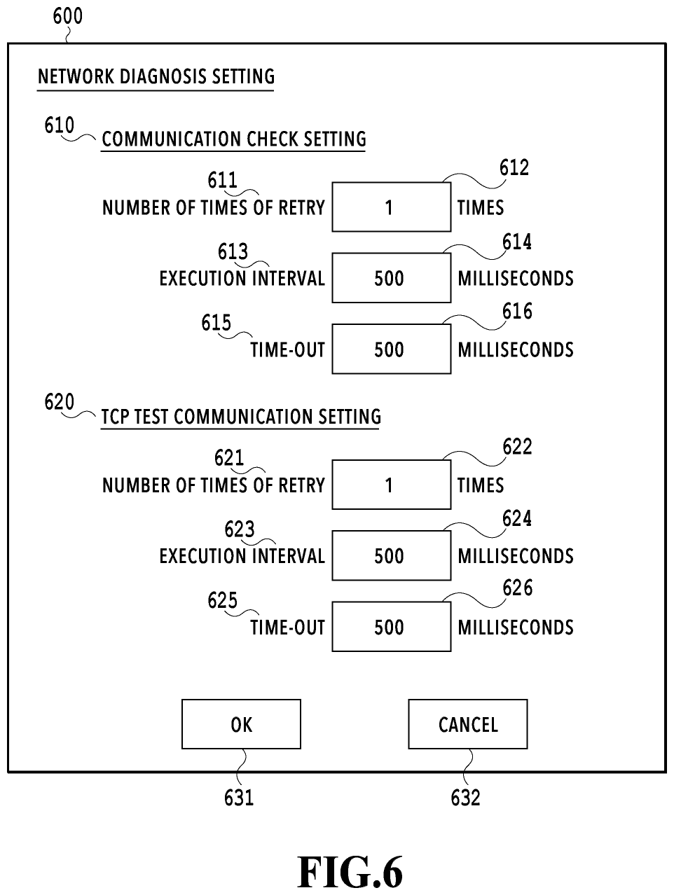

The network diagnosis unit 218 performs validity check (hereinafter, referred to as network diagnosis) of network communication settings held by the MFP 101 in the configuration of the system 100 illustrated in FIG. 1. In the network diagnosis, for example, whether an IP address, a subnet mask, and settings of the gateway 111 necessary for enabling network communication with the LAN 110 are correct or not is checked. Moreover, in the network diagnosis, whether the counterpart terminal 112 and the MFP 101 use the same IP address or not is checked. Furthermore, the network diagnosis unit 218 regularly performs a state check of physical communication links with the connected LANs 110 and 120, or performs the state check in response to an instruction from the reading control unit 209, the operation control unit 212, or the print control unit 217. In the case where the network diagnosis unit 218 detects disconnection of any of the communication links, the network diagnosis unit 218 notifies the reading control unit 209, the operation control unit 212, or the print control unit 217 of the disconnection. Moreover, in the case where the communication with the counterpart terminal being the communication partner fails in the print process or the transmission process of the scan data, the network diagnosis unit 218 can perform the processes described below. Specifically, for example, the network diagnosis flow illustrated in FIG. 7 enables checking of communication with the counterpart terminals 112 and 122 and diagnosis for identifying the failure factor by performing the TCP test communication. Note that, depending on the path to the destination terminal, there is a possibility that the number of times of execution of the communication check and the TCP test communication increases and the network diagnosis takes time to complete. Accordingly, in the communication check and the TCP test communication performed in the network diagnosis, the communication check and the TCP test communication are performed according to the number of times of retry/execution interval/time-out period set in a setting menu illustrated in FIG. 6, and this can reduce time required for the diagnosis.

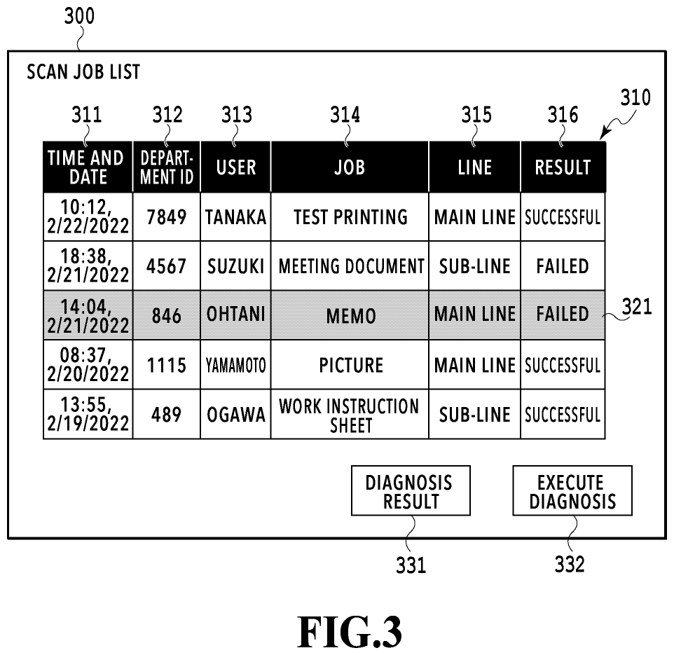

FIGS. 3 to 6 schematically illustrate examples of screen display on a display (touch panel display) included in the operation display unit 214 of the MFP 101.

### Scan Job List Screen

FIG. 3 is a diagram illustrating an example of a scan job list screen. The scan job list screen (UI screen) 300 is displayed on the operation display unit 214 of the MFP 101. The scan job list screen 300 is a screen illustrating a list of history of the job process result information managed by the job log management unit 220, and displays a list of scan jobs executed by the MFP 101. The scan jobs are scan-transmission jobs in which the image data obtained in the scanning by the reading unit 211 of the MFP 101 is transmitted to the counterpart terminal that is an external apparatus. The scan job list screen 300 displays a scan job list table 310, a diagnosis result button 331, and a diagnosis execution button 332.

In the scan job list table 310, pieces of information on items of time and date 311, department ID 312, user name 313, job name 314, line 315, and result 316 are managed in association with one another, and the history of the scan jobs executed in the MFP 101 is displayed in a list.

The time and date 311 displays time and date at which the MFP 101 executed each job. The department ID 312 displays an ID of a department to which the user instructing the execution of the job belongs. The user name 313 displays the name of the user instructing the execution of the job, and the job name 314 displays the name of the executed job.

The line 315 displays information indicating which one of the LAN 110 (main line) and the LAN 120 (sub-line) the scan job is transmitted to. The result 316 displays whether the execution result of the job is success or failure.

One job is selected from the scan job list table 310, and the diagnosis is performed. The configuration is preferably such that an NG job whose execution failed in the MFP 101 is set as the target of the diagnosis.

The diagnosis result button 331 is activated in the case where the network diagnosis result is included in the job process result information managed by the job log management unit 220, and is displayed to be capable of receiving a user operation. In the case where the diagnosis result button 331 is pressed by a user operation, a diagnosis result screen 400 to be described in detail later is displayed.

The diagnosis execution button 332 is a button for receiving an instruction of executing connection diagnosis irrespective of whether one scan job is selected from the scan job list table 310, and is displayed to be capable of receiving a user operation. In the case where the diagnosis execution button 332 is pressed, the network diagnosis unit 218 starts, based on the information managed in the setting management unit 206, the network diagnosis. Specifically, the network diagnosis is started only for internal devices of the MFP 101.

In the case where one scan job is selected from the scan job list table 310, the network diagnosis is executed for a line that is used in the selected scan job and that is indicated by the line 315. For example, in the case where a scan job 321 is selected, the network diagnosis is executed for the wired NIC 222 meaning the main line indicated by the line 315.

Meanwhile, in the case where one job is not selected from the list, the network diagnosis is executed for both of the wired NIC 222 meaning the main line and the wired NIC 223 meaning the sub-line. Then, after the completion of the network diagnosis for the wired NIC 222 and the wired NIC 223 that are the internal devices of the MFP 101, the diagnosis result screen 400 is displayed.

Note that, although explanation is given by using the scan job as an example in the present embodiment, the history list can be similarly displayed also for other client jobs and server jobs. Note that the client job is a job for requesting from the counterpart terminal connected via the network. The server job includes the print job in which the printing unit 215 of the MFP 101 executes printing instructed by the counterpart terminal and a data saving job in which data sent from the counterpart terminal being the external apparatus is saved in the nonvolatile memory 207 of the MFP 101. Moreover, although the case where the pieces of information on the items of time and date, department ID, user, job, line, and result are all associated with one another is explained above, the present disclosure is not limited to this. The pieces of information on two or more of the items of time and date, department ID, user, job, line, and result may be associated with one another, or these pieces of information may be further associated with information on another item.

### Network Diagnosis Result Screen

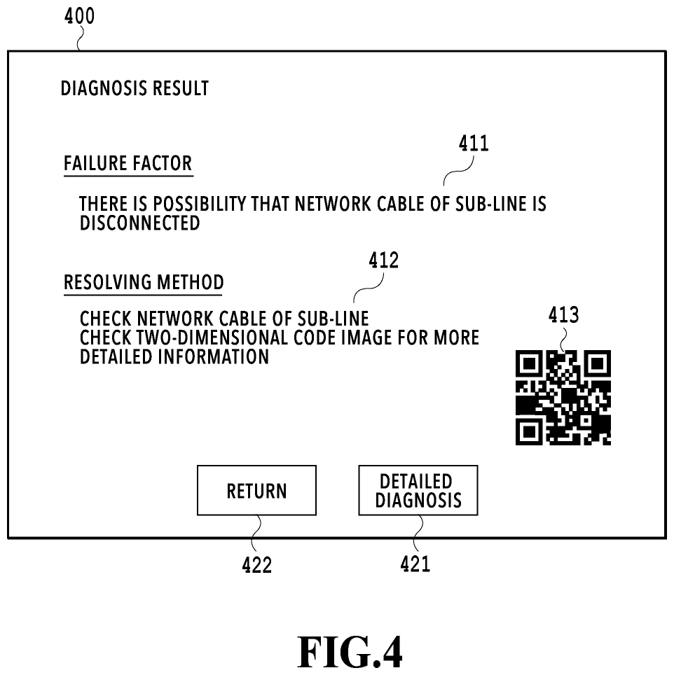

FIG. 4 is a diagram illustrating an example of a network diagnosis result screen. The network diagnosis result screen (UI screen) 400 is displayed on the operation display unit 214 of the MFP 101. The network diagnosis result screen 400 illustrates a result of the network diagnosis executed by the network diagnosis unit 218.

The network diagnosis result screen 400 is displayed in the case where the user operates the operation control unit 212 to press the diagnosis result button 331 and in the case where the network diagnosis executed by the pressing of the diagnosis execution button 332 is completed.

The network diagnosis result screen 400 displays a failure factor explanation message 411, a resolving method explanation message 412, a two-dimensional code image 413, a detailed diagnosis button 421, and a return button 422.

The failure factor explanation message 411 displays a message explaining a failure factor in the execution of the job. The resolving method explanation message 412 displays a resolving method of the failure factor that is a method of responding to the failure factor displayed in the failure factor explanation message 411.

Although the example in which one failure factor explanation message 411 and one resolving method explanation message 412 are displayed is illustrated in FIG. 4, the present disclosure is not limited to this. In the case where multiple failure factors and multiple resolving methods are conceivable, the messages as many as the number of conceived causes and resolving methods are displayed.

The two-dimensional code image 413 is a two-dimensional code image displayed in the case where information indicating the resolving method of the failure factor is described in a user manual browsable on the web. The two-dimensional code image 413 is a QR code (registered trademark) image in which a URL of a website where the user manual is present is encoded.

The detailed diagnosis button 421 is a button that receives an execution instruction. In the case where the detailed diagnosis button 421 is pressed by a user operation, the network diagnosis unit 218 starts the network diagnosis according to the network diagnosis flow illustrated in FIG. 7, and displays a network diagnosis on-going screen 500.

In the case where the return button 422 is pressed by a user operation, the diagnosis result screen 400 is closed, and the scan job list screen 300 is displayed.

Note that, although explanation is given by using the scan job as an example in the present embodiment, display can be similarly performed for other jobs such as the print job. Moreover, the message associated with each of the items of the failure factor and the resolving method is not limited to the example illustrated in FIG. 4, and other messages or the like may be displayed.

### Network Diagnosis On-going Screen

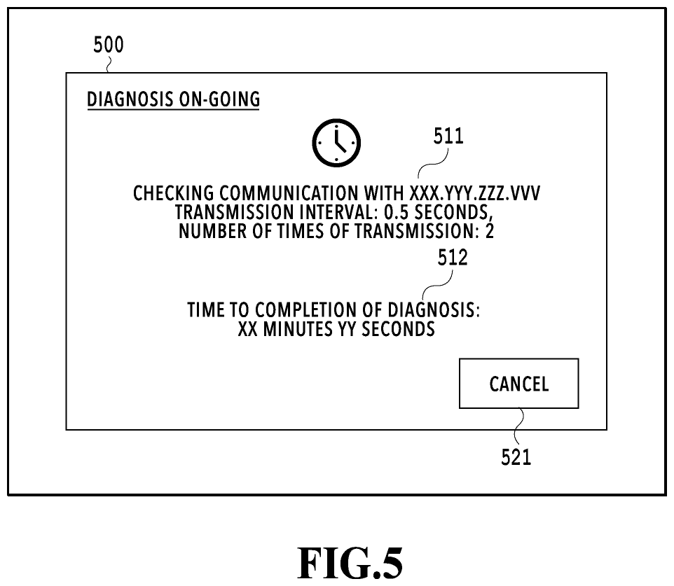

FIG. 5 is a diagram illustrating an example of the network diagnosis on-going screen. The network diagnosis on-going screen (UI screen) 500 is displayed on the operation display unit 214 of the MFP 101. The network diagnosis on-going screen 500 is a screen for notifying the user that the network diagnosis unit 218 is currently executing the network diagnosis. The network diagnosis on-going screen 500 displays a currently-executed process explanation message 511, an estimated completion time explanation message 512, and a cancel button 521.

The currently-executed process explanation message 511 displays a message explaining contents of a process currently executed in the network diagnosis. For example, in the case where a total of two ping requests (echo requests) are transmitted at an interval of 0.5 seconds to check communication with the gateway 114 (IP address of which is assumed to be xxx.yyy.zzz.vvv), the message illustrated in FIG. 5 is displayed.

The estimated completion time explanation message 512 displays time to completion of the network diagnosis process calculated by the network diagnosis unit 218. Since the number of times of execution of the communication check and the TCP test communication varies depending on the path to the destination terminal, the estimated completion time explanation message 512 is updated as necessary during the execution of the network diagnosis.

In the case where the execution of the network diagnosis is completed, the network diagnosis on-going screen 500 is closed, and the diagnosis result screen 400 is automatically displayed.

In the case where the cancel button 521 is pressed by a user operation, the network diagnosis unit 218 aborts the network diagnosis, and the diagnosis result screen 400 is displayed.

### Network Diagnosis Setting Screen

FIG. 6 is a diagram illustrating an example of a network diagnosis setting screen. The network diagnosis setting screen (UI screen) 600 is displayed on the operation display unit 214 of the MFP 101. In the network diagnosis setting screen 600, the communication check and the TCP test communication are set.

The network diagnosis setting screen 600 displays a communication check setting 610 and a TCP test communication setting 620 as a setting menu. The network diagnosis setting screen 600 displays an OK button 631 and a cancel button 632.

The communication check setting 610 and the TCP test communication setting 620 have the numbers of times of retry 611 and 621, execution intervals 613 and 623, and time-outs 615 and 625.

The numbers of times of retry 611 and 621 are each the number of times trials, the execution intervals 613 and 623 are each an interval between the trials in the case where the number of times of trials is set to two or more, and the time-outs 615 and 625 are each waiting time for a response from the counterpart terminal.

In the case where the communication check is given as an example, ping that is a command for checking the communication state of the network is issued for the counterpart terminal by using a command prompt (CMP). In ping, a ping request (echo request) is generally transmitted total of four times at an interval of one second with the response wait time set to one second for the counterpart terminal. The above-mentioned setting values in this case are such that the number of times of retry 611 is four, the execution interval 613 is 1,000 milliseconds, and the time-out 615 is 1,000 milliseconds.

There are input boxes 612, 614, 616, 622, 624, and 626 associated with the respective items, and setting values saved in the setting management unit 206 are displayed in the input boxes of the respective items in the case where the network diagnosis setting screen 600 is displayed.

The user can select the input boxes 612, 614, 616, 622, 624, and 626 and input the setting values by operating the operation display unit 214.

In the case where the OK button 631 is pressed by a user operation, the values inputted into the input boxes 612, 614, 616, 622, 624, and 626 are saved in the setting management unit 206, and the network diagnosis from here on is executed based on the present settings. In the case where the cancel button 632 is pressed by a user operation, saving of the values inputted into the input boxes 612, 614, 616, 622, 624, and 626 into the setting management unit 206 is cancelled, and the network diagnosis setting screen 600 is closed.

### Network Diagnosis Process

FIG. 7 is a flowchart illustrating a flow of the network diagnosis process. The network diagnosis process is performed by the network diagnosis unit. Note that the CPU 202 of the MFP 101 performs the series of processes illustrated in the flowchart of FIG. 7 by converting a control program stored in a memory such as the ROM 203 on the RAM 204, and executing the control program. The processes illustrated in FIG. 7 are started in the case where the network diagnosis is started.

In S701, the MFP 101 obtains a job type. Specifically, the MFP 101 obtains job type information from the job being the processing target as the job type, the job type information added to this job and indicating the type of this job. The job type includes, for example, the client job being a job that starts with the transmission request from the MFP 101 to the counterpart terminal and the server job being a job that starts with the reception of the request from the counterpart terminal.

In S702, the MFP 101 determines whether the job type obtained in S701 is the client job or not. In the case where the MFP 101 obtains a determination result that the job type obtained in S701 is the server job and is not the client job (NO in S702), the process proceeds to S721.

In S721, the MFP 101 obtains the error information from a job control unit (print control unit 217 in the present embodiment). Specifically, the MFP 101 obtains the error information in execution of the job. In S722, the MFP 101 obtains the setting values of the MFP 101 from the setting management unit 206. In S723, the MFP 101 performs, based on the error information obtained in S721 and the setting values obtained in S722, network diagnosis result determination. Specifically, the MFP 101 performs diagnosis by using the internal information of the MFP 101. Then, in the case where the process of S723 is completed, the process proceeds to S714. In the case where the flow has proceeded via the process of S723, in S714, the network diagnosis unit 218 (MFP 101) updates the display contents of the diagnosis result screen 400 to display contents corresponding to the diagnosis of S723.

Meanwhile, in the case where the MFP 101 obtains a determination result that the job type obtained in S701 is not the server job and is the client job (YES in S702), the process proceeds to S703.

In S703, the MFP 101 transmits the ping request (echo request) for checking the connection state with the gateway to a default gateway (gateway 111 or gateway 121). Specifically, the MFP 101 performs a check request that is an error diagnosis process using a signal for checking the network connection with the gateway and that is requesting the default gateway to check the communication state by transmitting a packet. Communication to the network layer in the open systems interconnection (OSI) reference model is checked.

In S704, the MFP 101 checks whether the ping response (reception of echo reply) from the default gateway (gateway 111 or gateway 121) is present or not. Specifically, the MFP 101 checks presence or absence of a response from the default gateway to the check request (transmission packet) of the communication state to the default gateway.

In the case where the MFP 101 obtains a check result that the ping response (reception of echo replay) is absent (NO in S704), the MFP 101 determines that there is a problem in a communication path with the default gateway, and the process proceeds to S713. In S713, the MFP 101 determines the network diagnosis result based on the communication check/TCP test communication. Specifically, in S713, the MFP 101 determines, based on the communication check result, that there is a problem in the communication path with the default gateway. Then, in S714, the network diagnosis unit 218 (MFP 101) updates the display contents of the diagnosis result screen according to the determination that there is a problem in the communication path with the default gateway.

### Diagnosis Result (Detailed) Screen

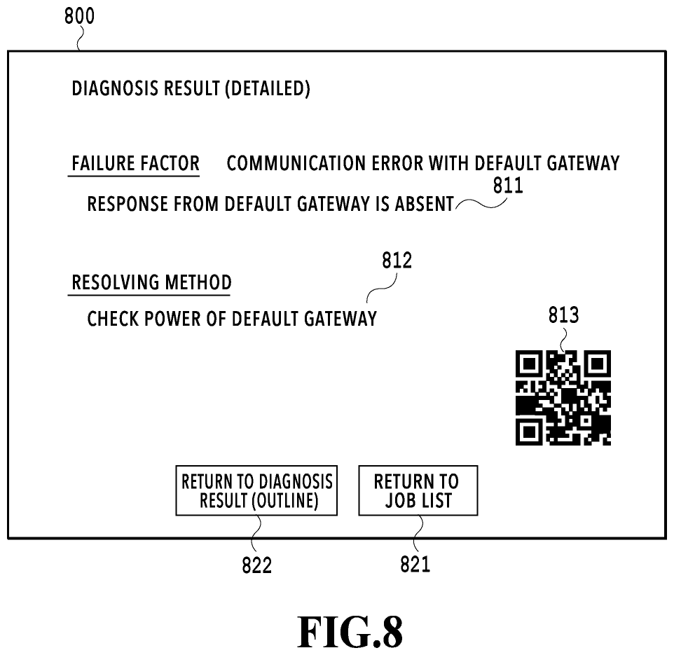

FIG. 8 is a diagram illustrating an example of a diagnosis result (detailed) screen after the update of the display contents, the example corresponding to the diagnosis (S713) in the case where the response to the ping transmission to the default gateway is absent.

The diagnosis result (detailed) screen (UI screen) 800 is displayed on the operation display unit 214 of the MFP 101. The diagnosis result (detailed) screen 800 is a screen displayed in the case where the detailed diagnosis button 421 is pressed in the network diagnosis result screen 400 to execute the network diagnosis process illustrated in FIG. 7 and the ping response from the default gateway is absent. The diagnosis result (detailed) screen 800 displays a failure factor explanation message 811, a resolving method explanation message 812, a two-dimensional code image 813, a button for return to job list 821, and a button for return to diagnosis result (outline) 822.

The failure factor explanation message 811 displays a message explaining the failure factor in the execution of the job. The resolving method explanation message 812 displays the resolving method of the failure factor that is a method of responding to the failure factor displayed in the failure factor explanation message 811.

Although the example in which one failure factor explanation message 811 and one resolving method explanation message 812 are displayed is illustrated in FIG. 8, the present disclosure is not limited to this. In the case where multiple failure factors and multiple resolving methods are conceivable, the messages as many as the number of conceived failure factors and resolving methods are displayed.

The two-dimensional code image 813 is a two-dimensional code image displayed in the case where the information indicating the resolving method of the failure factor is described in the user manual browsable on the web, and is a QR code image in which the URL of the website where the user manual is present is encoded.

In the case where the button for return to job list 821 is pressed by a user operation, the diagnosis result (detailed) screen 800 is closed, and the scan job list screen 300 is displayed.

In the case where the button for return to diagnosis result (outline) 822 is pressed by a user operation, the diagnosis result (detailed) screen 800 is closed, and the diagnosis result screen 400 is displayed.

Note that, although explanation is given by using the scan job as an example in the present embodiment, display can be similarly performed for other jobs such as the print job. Moreover, the message associated with each of the items of the failure factor and the resolving method is not limited to the example illustrated in FIG. 8, and other messages or the like may be displayed.

Meanwhile, in the case where the MFP 101 obtains a check result that the ping response (reception of echo reply) is present (YES in S704), the process proceeds to S705. In S705, the MFP 101 checks presence or absence of a diagnosis cancelling request made by pressing of the cancel button 521 in the diagnosis on-going screen 500.

In S706, the MFP 101 determines whether the diagnosis cancelling request (cancel instruction) is present or not. In the case where the MFP 101 obtains a determination result that the diagnosis cancelling request is present (NO in S706), the process illustrated in FIG. 7 is terminated. Specifically, in the case where the MFP 101 determines that the diagnosis cancelling request is present, the MFP 101 immediately terminates the network diagnosis process without performing the diagnosis process or the update process of the diagnosis result screen. Meanwhile, in the case where the MFP 101 obtains a determination result that the diagnosis cancelling request is absent (YES in S706), the process proceeds to S707. In S707, the MFP 101 transmits the ping request (echo request) to the counterpart terminal. Specifically, the MFP 101 performs a check request that is an error diagnosis process using a signal for checking the network connection with the counterpart terminal and that is requesting the counterpart terminal to check the communication state by transmitting a packet. The communication to the network layer in the OSI reference model is checked.

In S708, the MFP 101 checks whether the ping response (reception of echo reply) from the counterpart terminal is present or not. Specifically, the MFP 101 checks presence or absence of a response from the counterpart terminal to the check request (transmission packet) of the communication state to the counterpart terminal. In the case where the MFP 101 obtains a check result that the ping response (reception of echo replay) is absent (NO in S708), the MFP 101 determines that there is a problem in the communication path with the counterpart terminal, and the process proceeds to S713. In S713, the MFP 101 determines the network diagnosis result based on the communication check/TCP test communication. Specifically, in S713, the MFP 101 determines that there is a problem in the communication path with the counterpart terminal. Then, in S714, the network diagnosis unit 218 (MFP 101) updates the display contents of the diagnosis result screen according to the diagnosis that there is a problem in the communication path with the counterpart terminal.

### Diagnosis Result (Detailed) Screen

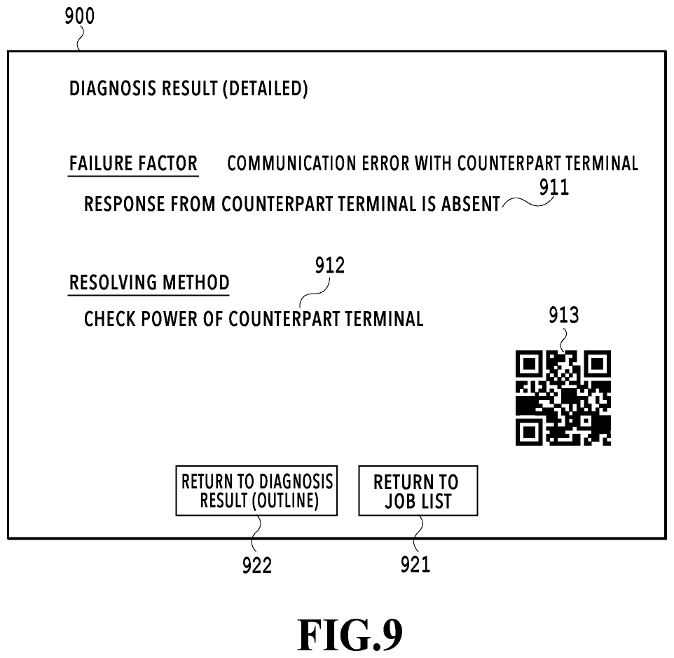

FIG. 9 is a diagram illustrating an example of the diagnosis result (detailed) screen after the update of the display contents, the example corresponding to the diagnosis (S713) in the case where the response to the ping transmission to the counterpart terminal is absent.

The diagnosis result (detailed) screen (UI screen) 900 is displayed on the operation display unit 214 of the MFP 101. The diagnosis result (detailed) screen 900 is a screen displayed in the case where the detailed diagnosis button 421 is pressed in the network diagnosis result screen 400 to execute the network diagnosis process illustrated in FIG. 7 and the ping response from the counterpart terminal is absent. The diagnosis result (detailed) screen 900 displays a failure factor explanation message 911, a resolving method explanation message 912, a two-dimensional code image 913, a button for return to job list 921, and a button for return to diagnosis result (outline) 922.

The failure factor explanation message 911 displays a message explaining the failure factor in the execution of the job. The resolving method explanation message 912 displays the resolving method of the failure factor that is a method of responding to the failure factor displayed in the failure factor explanation message 911.

Although the example in which one failure factor explanation message 911 and one resolving method explanation message 912 are displayed is illustrated in FIG. 9, the present disclosure is not limited to this. In the case where multiple failure factors and multiple resolving methods are conceivable, the messages as many as the number of conceived failure factors and resolving methods are displayed.

The two-dimensional code image 913 is a two-dimensional code image displayed in the case where the information indicating the resolving method of the failure factor is described in the user manual browsable on the web, and is a QR code image in which the URL of the website where the user manual is present is encoded.

In the case where the button for return to job list 921 is pressed by a user operation, the diagnosis result (detailed) screen 900 is closed, and the scan job list screen 300 is displayed.

In the case where the button for return to diagnosis result (outline) 922 is pressed by a user operation, the diagnosis result (detailed) screen 900 is closed, and the diagnosis result screen 400 is displayed.

Note that, although explanation is given by using the scan job as an example in the present embodiment, display can be similarly performed for other jobs such as the print job. Moreover, the message associated with each of the items of the failure factor and the resolving method is not limited to the example illustrated in FIG. 9, and other messages or the like may be displayed.

Meanwhile, in the case where the MFP 101 obtains a check result that the ping response (reception of echo reply) is present (YES in S708), the process proceeds to S709. In S709, the MFP 101 performs TCP test communication (three-way handshake) with the counterpart terminal. Specifically, this communication can be referred to as a process in which network connection with the counterpart terminal is checked and that uses a signal for performing check of TCP connection. The communication to the transport layer in the OSI reference model is checked. In S710, the MFP 101 checks whether the TCP test communication (three-way handshake) has been successful or not.

In the case where the MFP 101 obtains a determination result that the TCP test communication (three-way handshake) has failed (NO in S710), the MFP 101 determines that there is a problem in the TCP communication with the counterpart terminal, and the process proceeds to S713. In S713, the MFP 101 determines the network diagnosis result based on the communication check/TCP test communication. Specifically, in S713, the MFP 101 determines that there is a problem in the TCP communication with the counterpart terminal. Then, in S714, the network diagnosis unit 218 (MFP 101) updates the display contents of the diagnosis result screen according to the diagnosis that there is a problem in the TCP communication with the counterpart terminal.

### Diagnosis Result (Detailed) Screen

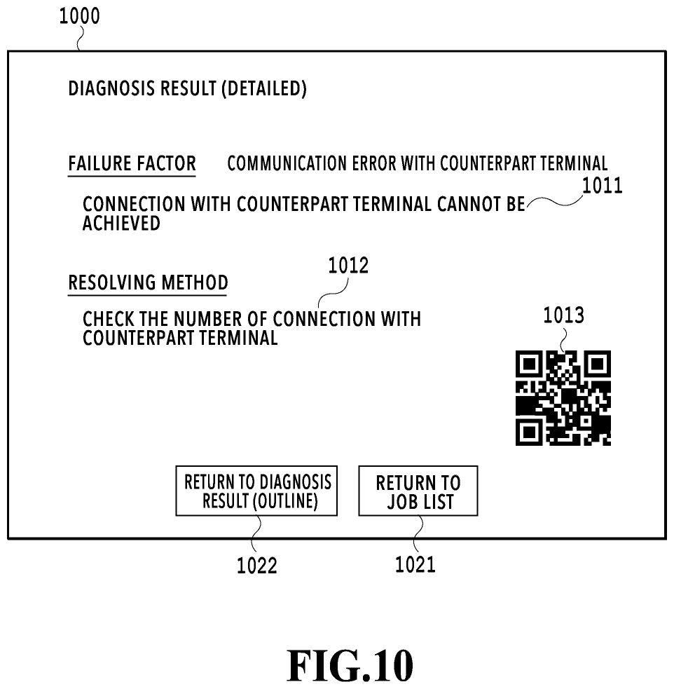

FIG. 10 is a diagram illustrating an example of the diagnosis result (detailed) screen after the update of the display contents, the example corresponding to the diagnosis (S713) in the case where the TCP test communication fails.

The diagnosis result (detailed) screen (UI screen) 1000 is displayed on the operation display unit 214 of the MFP 101. The diagnosis result (detailed) screen 1000 is a screen displayed in the case where the detailed diagnosis button 421 is pressed in the network diagnosis result screen 400 to execute the network diagnosis process illustrated in FIG. 7 and the TCP test communication fails. The diagnosis result (detailed) screen 1000 displays a failure factor explanation message 1011, a resolving method explanation message 1012, a two-dimensional code image 1013, a button for return to job list 1021, and a button for return to diagnosis result (outline) 1022.

The failure factor explanation message 1011 displays a message explaining the failure factor in the execution of the job. The resolving method explanation message 1012 displays the resolving method of the failure factor that is a method of responding to the failure factor displayed in the failure factor explanation message 1011.

Although the example in which one failure factor explanation message 1011 and one resolving method explanation message 1012 are displayed is illustrated in FIG. 10, the present disclosure is not limited to this. In the case where multiple failure factors and multiple resolving methods are conceivable, the messages as many as the number of conceived failure factors and resolving methods are displayed.

The two-dimensional code image 1013 is a two-dimensional code image displayed in the case where the information indicating the resolving method of the failure factor is described in the user manual browsable on the web, and is a QR code image in which the URL of the website where the user manual is present is encoded.

In the case where the button for return to job list 1021 is pressed by a user operation, the diagnosis result (detailed) screen 1000 is closed, and the scan job list screen 300 is displayed.

In the case where the button for return to diagnosis result (outline) 1022 is pressed by a user operation, the diagnosis result (detailed) screen 1000 is closed, and the diagnosis result screen 400 is displayed.

Note that, although explanation is given by using the scan job as an example in the present embodiment, display can be similarly performed for other jobs such as the print job. Moreover, the message associated with each of the items of the failure factor and the resolving method is not limited to the example illustrated in FIG. 10, and other messages or the like may be displayed.

Meanwhile, in the case where the MFP 101 obtains a determination result that the TCP test communication (three-way handshake) has been successful (YES in S710), the process proceeds to S711. In S711, the MFP 101 checks whether the counterpart terminal for which the TCP test communication has been successful is the destination terminal of the job or not. In S712, the MFP 101 determines whether the counterpart terminal for which the TCP test has been successful is the destination terminal of the job or not.

In the case where the MFP 101 obtains a determination result that the counterpart terminal for which the TCP test has been successful is the destination terminal of the job (YES in S712), the MFP 101 determines that there is a problem in the destination terminal, and the process proceeds to S713. In S713, the MFP 101 determines the network diagnosis result based on the communication check/TCP test communication. Specifically, in S713, the MFP 101 determines that there is a problem in the destination terminal. Then, in S714, the network diagnosis unit 218 (MFP 101) updates the display contents of the diagnosis result screen according to the diagnosis that there is a problem in the destination terminal.

### Diagnosis Result (Detailed) Screen

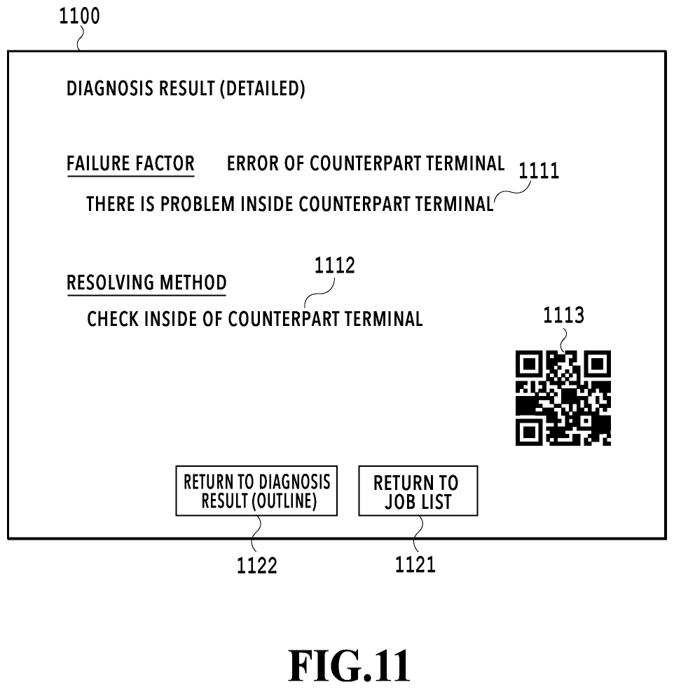

FIG. 11 is a diagram illustrating an example of the diagnosis result (detailed) screen after the update of the display contents, the example corresponding to the diagnosis (S713) in the case where the counterpart terminal is the destination terminal.

The diagnosis result (detailed) screen (UI screen) 1100 is displayed on the operation display unit 214 of the MFP 101. The diagnosis result (detailed) screen 1100 is a screen displayed in the case where the detailed diagnosis button 421 is pressed in the network diagnosis result screen 400 to execute the network diagnosis process illustrated in FIG. 7 and the counterpart terminal is the destination terminal. The diagnosis result (detailed) screen 1100 displays a failure factor explanation message 1111, a resolving method explanation message 1112, a two-dimensional code image 1113, a button for return to job list 1121, and a button for return to diagnosis result (outline) 1122.

The failure factor explanation message 1111 displays a message explaining the failure factor in the execution of the job. The resolving method explanation message 1112 displays the resolving method of the failure factor that is a method of responding to the failure factor displayed in the failure factor explanation message 1111.

Although the example in which one failure factor explanation message 1111 and one resolving method explanation message 1112 are displayed is illustrated in FIG. 11, the present disclosure is not limited to this. In the case where multiple failure factors and multiple resolving methods are conceivable, the messages as many as the number of conceived failure factors and resolving methods are displayed.

The two-dimensional code image 1113 is a two-dimensional code image displayed in the case where the information indicating the resolving method of the failure factor is described in the user manual browsable on the web, and is a QR code image in which the URL of the website where the user manual is present is encoded.

In the case where the button for return to job list 1121 is pressed by a user operation, the diagnosis result (detailed) screen 1100 is closed, and the scan job list screen 300 is displayed.

In the case where the button for return to diagnosis result (outline) 1122 is pressed by a user operation, the diagnosis result (detailed) screen 1100 is closed, and the diagnosis result screen 400 is displayed.

Note that, although explanation is given by using the scan job as an example in the present embodiment, display can be similarly performed for other jobs such as the print job. Moreover, the message associated with each of the items of the failure factor and the resolving method is not limited to the example illustrated in FIG. 11, and other messages or the like may be displayed.

Meanwhile, in the case where the MFP 101 obtains a determination result that the counterpart terminal for which the TCP test has been successful is not the destination terminal of the job (NO in S712), the process returns to S705. Then the processes of S705 to S712 are repeatedly executed until there is a cancel request, there is no response to the ping transmission to the counterpart terminal, the TCP test communication fails, or the counterpart terminal is the destination terminal.

The determination result further identifying a root cause can be thereby presented to the user.

As explained above, according to the present embodiment, it is possible to efficiently diagnose the failure factor of the job. In the case where execution of the job that involves transmission to the external apparatus connected via the network fails, error diagnosis using the signal (for example, ping or TCP test communication) for checking the network connection with the external apparatus is performed.

In the case where there is no response to the ping transmission to the default gateway, the failure factor can be narrowed down to devices present between the MFP and the default gateway instead of an entire section between the MFP and the counterpart terminal being the destination. Specifically, the failure factor can be narrowed down to, for example, the wired NIC, the LAN between the MFP and the default gateway, and the default gateway.

In the case where there is a response to the ping transmission to the default gateway but no response to the ping transmission to the counterpart terminal, the failure factor can be narrowed down to devices between the default gateway and the counterpart terminal instead of the entire section between the MFP and the counterpart terminal being the destination. Specifically, the failure factor can be narrowed down to, for example, the LAN between the default gateway and the counterpart terminal and the counterpart terminal.

In the case where there are responses to the ping transmission to the default gateway and the counterpart terminal but no response to the TCP communication to the counterpart terminal, the failure factor can be narrowed down to the settings of the MFP instead of the entire section between the MFP and the counterpart terminal being the destination. In the case where there are responses to the ping transmission to the default gateway and the counterpart terminal and to the TCP communication to the counterpart terminal and the counterpart terminal is the destination terminal, the failure factor can be narrowed down to the counterpart terminal being the destination instead of the entire section between the MFP and the counterpart terminal being the destination.

In the case where execution of the job involving reception from the external apparatus connected via the network fails, the error diagnosis using the signal for checking the network connection with the external apparatus is not performed, but the error diagnosis using the error information in the failure of the execution of the job is performed. The failure factor of the job can be diagnosed more efficiently by an amount corresponding to omission of the error diagnosis using the signal.

Note that, although the case where the present disclosure is applied to the job using the wired communication is described above, the present disclosure is not limited to this, and may be applied to a job using wireless communication. In the case where the MFP 101 performs the diagnosis process illustrated in FIG. 7 on the job using the wireless communication and obtains the determination result that the reply to the transmission of ping to the default gateway is absent, the display contents of the diagnosis result screen may be updated to the diagnosis result (detailed) screen described below. Specifically, “please check electric wave” may be displayed in the resolving method of the diagnosis result (detailed) screen.

### Other Embodiments

The present disclosure is not limited to the above-mentioned embodiment, and various modifications may be made, and parts of the above-mentioned embodiment may be combined as appropriate.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

According to the present embodiment, time required for diagnosis can be reduced.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-095253, filed Jun. 12, 2024, which is hereby incorporated by reference herein in its entirety.

What is claimed is:

1. An information processing apparatus capable of executing jobs, the information processing apparatus comprising:
one or more memories storing instructions; and
one or more processors executing the instructions to:
obtain job information on a job selected from among the jobs executed in the information processing apparatus; and
perform diagnosis on the selected job by using the job information, wherein
in a case where a type of job indicated in the obtained job information is a type of job involving transmission to an external apparatus connected via a network, the diagnosis using a signal for checking network connection with the external apparatus is performed, and
in a case where the type of job indicated in the obtained job information is not the type of job involving transmission to the external apparatus connected via the network, the diagnosis is performed without use of the signal.

2. The information processing apparatus according to claim 1, wherein, in a case where the type of job indicated in the obtained job information is a type of job involving reception from the external apparatus connected via the network, the diagnosis using information in execution of the job is performed without use of the signal.

3. The information processing apparatus according to claim 2, wherein, in the case where the type of job indicated in the obtained job information is the type of job involving reception from the external apparatus, the diagnosis using a setting value set in the information processing apparatus in addition to the information in execution of the job is performed.

4. The information processing apparatus according to claim 2, wherein the type of job involving reception from the external apparatus is a print job in which printing instructed by the external apparatus is executed or a data saving job in which saving of data transmitted from the external apparatus into a saving unit of the information processing apparatus is executed.

5. The information processing apparatus according to claim 1, wherein, in the case where the obtained type of job is the type of job involving transmission to the external apparatus, the diagnosis is performed by performing check, using the signal, of a communication state with the external apparatus.

6. The information processing apparatus according to claim 1, wherein, in the case where the obtained type of job is the type of job involving transmission to the external apparatus, the diagnosis is performed by performing check, using the signal, of a communication state with a gateway, the gateway being present in the network between the information processing apparatus and the external apparatus.

7. The information processing apparatus according to claim 6, wherein, in a case where the obtained type of job is the type of job involving transmission to the external apparatus and a response from the gateway is present in the check of the communication state with the gateway, the diagnosis is performed by performing check, using the signal, of a communication state with the external apparatus.

8. The information processing apparatus according to claim 7, wherein, in a case where the obtained type of job is the type of job involving transmission to the external apparatus and the response from the gateway and a response from the external apparatus are present in the check of the communication states with the gateway and the external apparatus, the diagnosis is performed by performing check, using the signal, of TCP connection with the external apparatus.

9. The information processing apparatus according to claim 6, wherein,
in a case where
the obtained type of job is the type of job involving transmission to the external apparatus,
responses from the gateway and the external apparatus are present in the check of the communication state with the gateway and check of a communication state with the external apparatus, and
TCP connection with the external apparatus that uses the signal is successful,
the diagnosis is performed by performing determination of whether the external apparatus is a destination of the job or not.

10. The information processing apparatus according to claim 1, wherein the type of job involving transmission to the external apparatus is a scan-transmission job in which image data obtained by scanning with a reading unit of the information processing apparatus is transmitted to the external apparatus.

11. The information processing apparatus according to claim 1, wherein the processors execute the instructions to display a screen including a result of the diagnosis.

12. The information processing apparatus according to claim 5, wherein the processors execute the instructions to display a diagnosis on-going screen that includes a cancel button configured to receive an instruction to cancel the diagnosis in a case where the diagnosis using the signal is performed.

13. The information processing apparatus according to claim 12, wherein details of the diagnosis using the signal and time to completion of the diagnosis using the signal are displayed in the diagnosis on-going screen.

14. The information processing apparatus according to claim 11, wherein a two-dimensional code in which a URL of a website is encoded is further displayed in the screen, the website being a website where information indicating a resolving method of a failure factor is present.

15. A controlling method of an information processing apparatus capable of executing jobs, the controlling method comprising:
obtaining job information on a job selected from among the jobs executed in the information processing apparatus; and
performing diagnosis on the selected job by using the job information, wherein in a case where a type of job indicated in the obtained job information is a type of job involving transmission to an external apparatus connected via a network, the diagnosis using a signal for checking network connection with the external apparatus is performed, and
in a case where the type of job indicated in the obtained job information is not the type of job involving transmission to the external apparatus connected via the network, the diagnosis is performed without use of the signal.

16. A non-transitory computer readable storage medium storing a program for causing a computer to perform a controlling method for an information processing apparatus capable of executing jobs, the controlling method comprising:
obtaining job information on a job selected from among the jobs executed in the information processing apparatus; and
performing diagnosis on the selected job by using the job information, wherein
in a case where a type of job indicated in the obtained job information is a type of job involving transmission to an external apparatus connected via a network, the diagnosis using a signal for checking network connection with the external apparatus is performed, and
in a case where the type of job indicated in the obtained job information is not the type of job involving transmission to the external apparatus connected via the network, the diagnosis is performed without use of the signal.
